(19) United States
(12) Patent Application Publication
(10) Pub. No.: US 2004/0005977 A1
(43) Pub. Date: Jan. 8, 2004

(54) Carton forming machine

(76) Inventor: William John Scholtes, Victoria (AU)

Correspondence Address: Dillworth & Barrese, 333 Earle Ovington Boulevard, Uniondale, NY, 11553, US

(21) Appl. No.: 10/343,032

(22) PCT Filed: Jul. 26, 2001
(86) PCT No.: PCT/AU01/00913

(30) Foreign Application Priority Data
Jul. 27, 2000 (AU) PQ 9060

(51) Int. Cl. B31B 3/02

(52) U.S. Cl. 493/71

(57) ABSTRACT

A carton forming machine having a blank feeding section (1) which receives blanks from stacked supplies of blanks (10, 11) means (2) for gluing folding and compressing side wall of the blank to form reinforced side walls and end flaps, mandrel means (3) about which the blanks are folded, glued and held to form an open topped carton, the mandrel means including first and second mandrels mounted on a rotating turret (15) and having associated blank holding means (17, 18) the machine being operable to rotate the mandrels when a carton has been formed while the carton is held by the holding means to ensure that the glue sets and to present an empty mandrel about which the next blank is to be folded, thereby ensuring that the throughput of the machine is not compromised while the glue sets.

### FIELD OF THE INVENTION

This invention relates to carton or case forming machines.

### BACKGROUND OF THE INVENTION

Carton or case forming and filling machines are now widely used in the packaging of consumer products such as beverages. Such machines must be capable of automatically erecting and sealing the carton or case ready for filling by means of a separate filling apparatus.

Examples of case forming machines may be found in the patent literature, and include Australian Patent No. 640503, and U.S. Pat. No. 5,147,271, in both of which a corrugated cardboard blank is formed around a mandrel where the side and end panels are glued and the partly erected box ejected from the mandrel as an open-topped box ready for filling.

In our International Patent Application PCT/AU00/01215, the contents of which are incorporated herein by cross reference, we described a reinforced container suitable for a fluid-filled bags or other contents, formed from corrugated board or similar packaging materials and including side panels having extension portions which are foldable and secured to form double thickness side panels and end flaps which serve to reinforce the side and end panels of the container in the manner described in the above application. It will be appreciated that the blank for forming the improved reinforced container is large and requires a modified flap folding arrangement in which the side flaps are initially folded lengthwise rather than transversely, as is usually the case, followed by folding of the blank around a mandrel to form the carton.

### SUMMARY OF THE INVENTION AND OBJECT

It is an object of the present invention to provide an improved case forming machine in which the supplies of blanks for forming the box or carton are specially arranged to achieve continuity of supply to the forming machine and the blanks are folded in a manner which ensures continuous operation at a relatively high throughput.

In a first aspect, the invention provides a case or carton forming machine having a blank feeding means, means for supporting stacked supplies of blanks for forming the box or carton at spaced positions relative to the feeding means, means for moving the blanks from each of said supplies to the blank feeding means, said moving means operating to take blanks from one supply until it is exhausted, and means for causing the moving means to take blanks from the other supply to enable the exhausted supply to be replenished while the moving means continues to supply blanks to the feeding means.

By providing alternative stacked supplies of blanks from which the feeding means can supply blanks to the blank feeding means, the forming machine is able to operate continuously to supply blanks to the forming apparatus without interruption, thereby resulting in more efficient operation of the forming machine.

In a preferred arrangement, the stacked supplies of blanks are located at either side of the blank feeding means and a mechanism is provided to transfer blocks of blanks to the blank feeding means to maintain a supply of blanks at the feeding means. The mechanism may include a block pusher associated with each stacked supply which includes a stack elevating means for maintaining each stack at the required level for transfer of blocks of blanks to the feeding means.

In a second aspect, the invention provides a case or carton forming machine having a blank feeding means which receives blanks from a stacked supply of blanks, means for gluing, folding and compressing side wall flaps of the blank to for reinforced side walls and end flaps, mandrel means about which glued blanks are folded and held to form an open case or carton, said mandrel means including first and second mandrels mounted in spaced relation on a rotating turret which also carries associated blank holding means associated with each mandrel and including flap clamping means for holding closure flaps of the blank in place while the glue sets, said machine being operable to rotate the mandrels when a case or carton has been formed on a mandrel while the case or carton is held by said blank holding means to ensure that the glue sets and to present an empty mandrel about which the next blank is to be folded, thereby ensuring that throughput is not compromised while the glue sets.

The means for folding the blanks on the mandrel means may take any suitable form known in the art, such as movable folding arms of the type described in the Australian and United States patents referred to above.

In another aspect, the invention provides a case or carton forming machine including blank feeding means operative to move the blanks in a predetermined direction, spaced side flap folding means for folding side wall flaps at opposite sides of the blanks in the direction of movement of the blanks about a predetermined fold line extending transverse to said direction, said folding means including means for confining the folding of the side wall flaps to said predetermined fold line.

In a preferred form, the confining means includes a travelling carriage means which moves with the blank and has means for holding the blank as it is folded about the predetermined folding line. The machine may also include means, such as centre wheels or a driven hold down belt, to hold the centre of the blank down as the side wall flaps are folded.

The spaced flap folding means may comprise any known form of flap folding mechanisms, such as rotating folding arms and/or static guides or hoops operating as fixed flap folding ploughs, which operate to fold the side flaps longitudinally as the blank is moved by the feeding means. Initial bending of the side flaps through about 90° while the travelling carriage holds the blank may be way of rotating folding arms, and this folding operation may be followed by the use of suitable ploughs to complete the folding of the side flaps through 180°.

Following the above folding operation, the side flaps are held in compression by rollers or a belt for a period sufficient to ensure that the glue between the folded flap portions sets.

### BRIEF DESCRIPTION OF THE DRAWINGS

In order that the invention may be more readily understood, a presently preferred embodiment of the invention will now be described with reference to the accompanying drawings in which:

FIGS. 1 & 2 are partly schematic perspective views from opposite directions of a case forming machine embodying the invention, and

FIG. 3 is a plan view of the machine of FIGS. 1 and 2;

FIGS. 4 and 5 are partly schematic perspective views of the blank feed section of the machine;

FIG. 6 is a partly schematic view of the blank flap folding and forming section of the machine;

FIGS. 7 and 8 are partly schematic views of the rotating mandrels of the machine.

FIG. 9 schematically illustrates the blank folding sequence according to the preferred form of the invention.

### DESCRIPTION OF PREFERRED EMBODIMENT

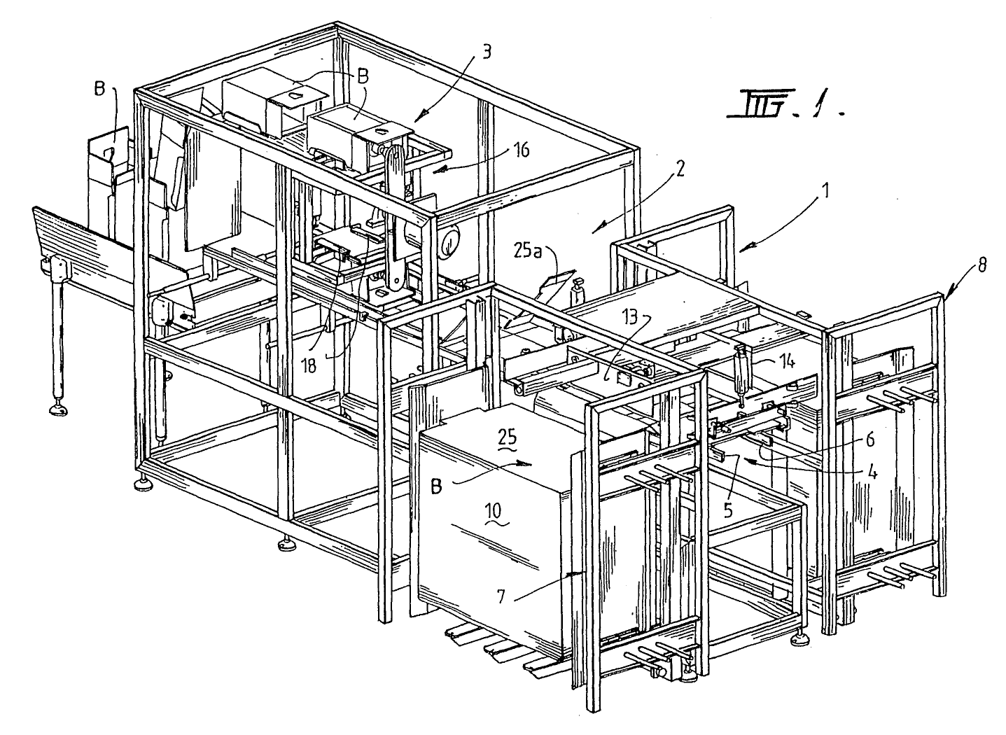

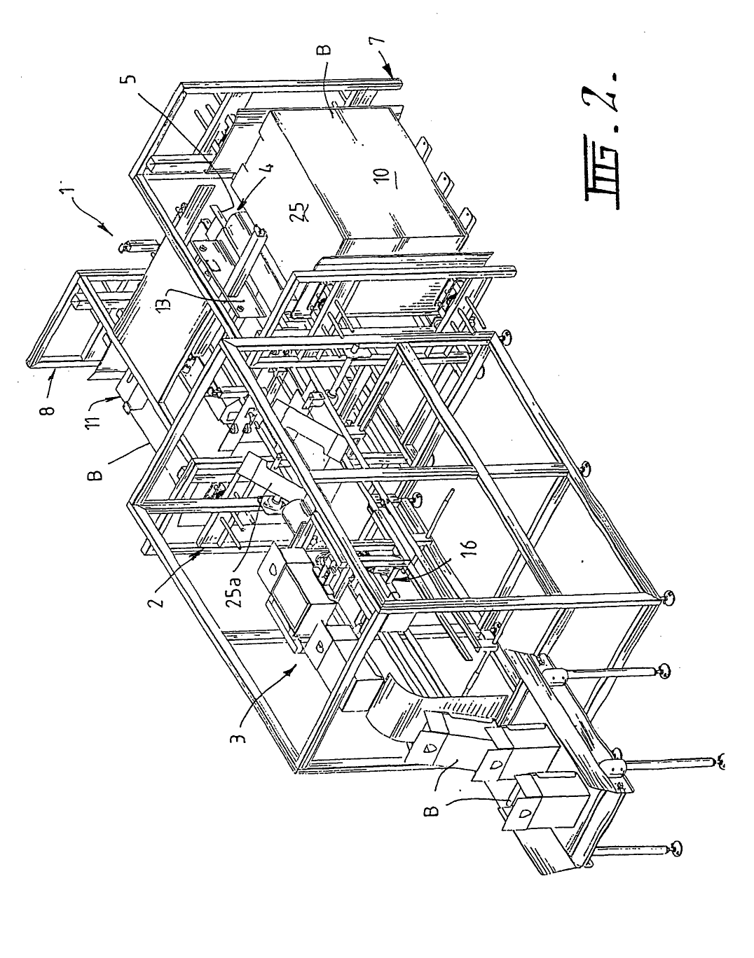

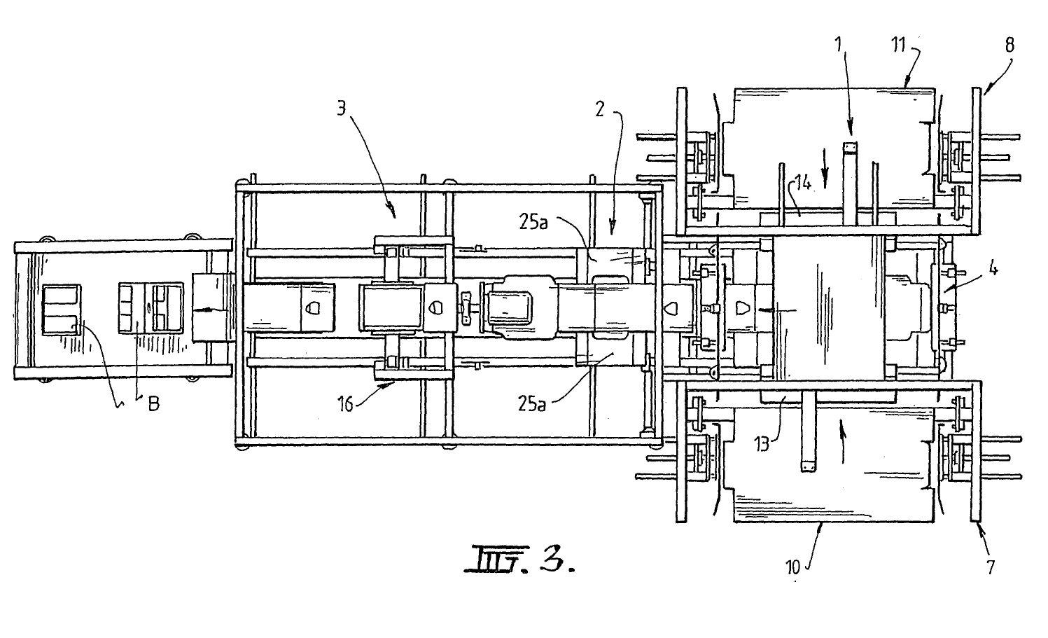

Referring firstly to FIGS. 1 and 2 of the drawings, the case forming machine embodying the invention includes a blank supply/feeding section 1, a blank side flap folding and forming section 2, and a case forming rotating, mandrel section 3.

The blank supply/feeding section 1 includes table 4 having blank supporting rails 5, 6 and blank supply magazines 7, 8 positioned on either side of the table 4. The blank supply magazine 7, 8 include blank stack supporting forks mounted for elevating movement in a manner not illustrated, so that the top of each stack 10, 11 of blanks 12 are maintained at the required height for transfer of blocks of blanks by block pushers 13, 14 associated with the supply magazines 7, 8 to the blank feeding table 4.

The block pushers 13 are controlled by computer means (not shown) to push blanks B from the stacks 10 or 11 until one of the stacks 10 or 11 is exhausted, whereupon the other pusher 14 is instructed by the computer means to push blocks of blanks from the other stack 11. Such an arrangement provides the advantage of continuity of supply of blanks to the feeding means since the exhausted stack 10 can be replenished without any break in the carton forming operation.

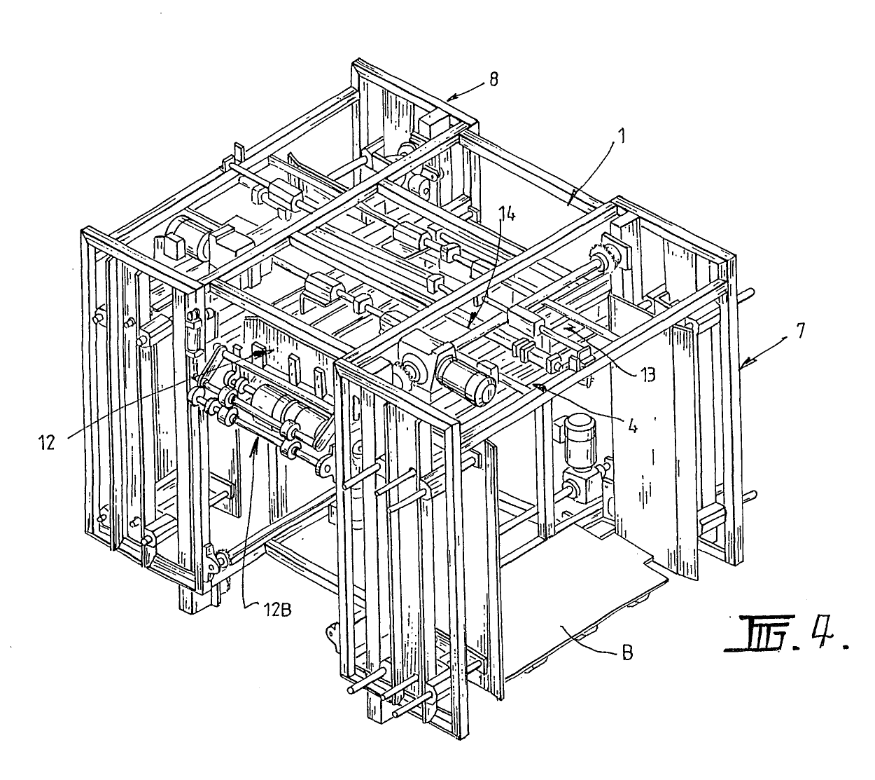

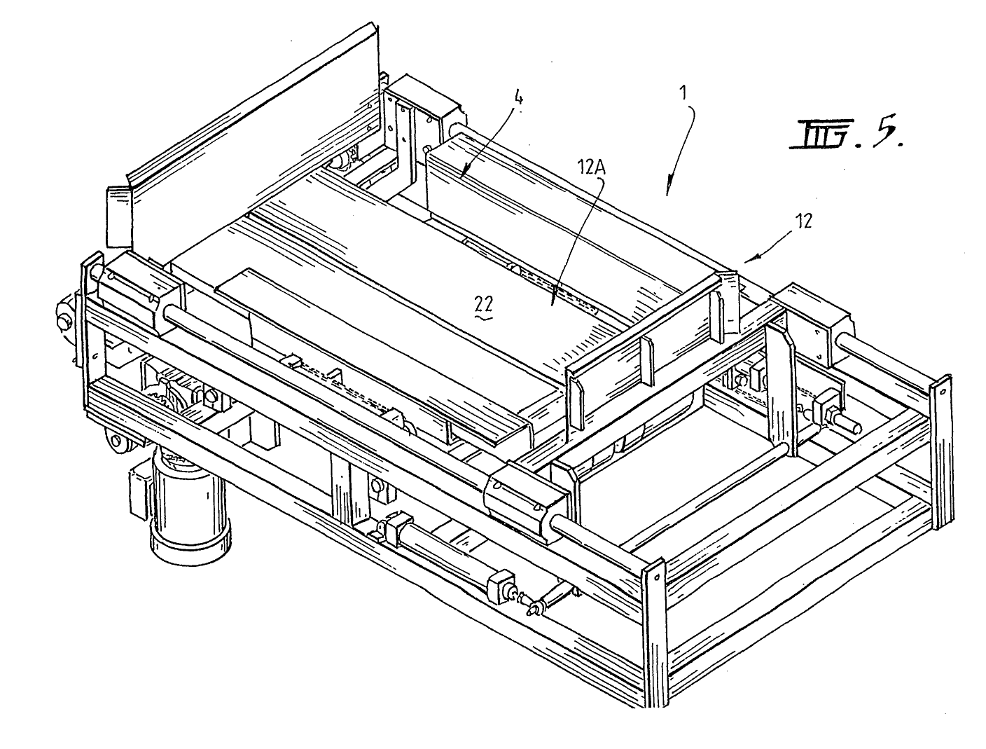

A bank feeding mechanism 12 is associated with the table for continually feeding individual blanks B from the bottom of the block of blanks supported by the table 4. The feeding mechanism 12 (FIGS. 4 and 5) includes a belt drive 12a at the bottom of the feeder to feed the bottom blank in the block into a set of nip or pinch rollers 12b located at the leading edge of the feeder 12 to propel the blanks B forward and create a gap before the next blank is presented to the system. The blank is transferred by a dog (not shown) pushing the trailing edge of the blank B which conveys continuously to the mandrel.

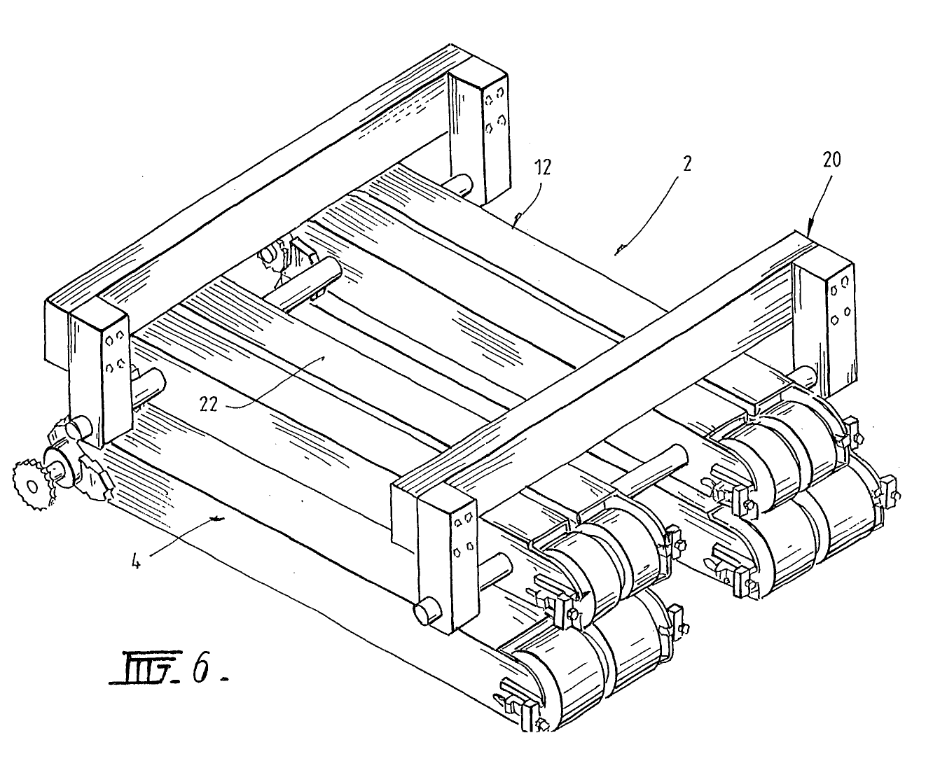

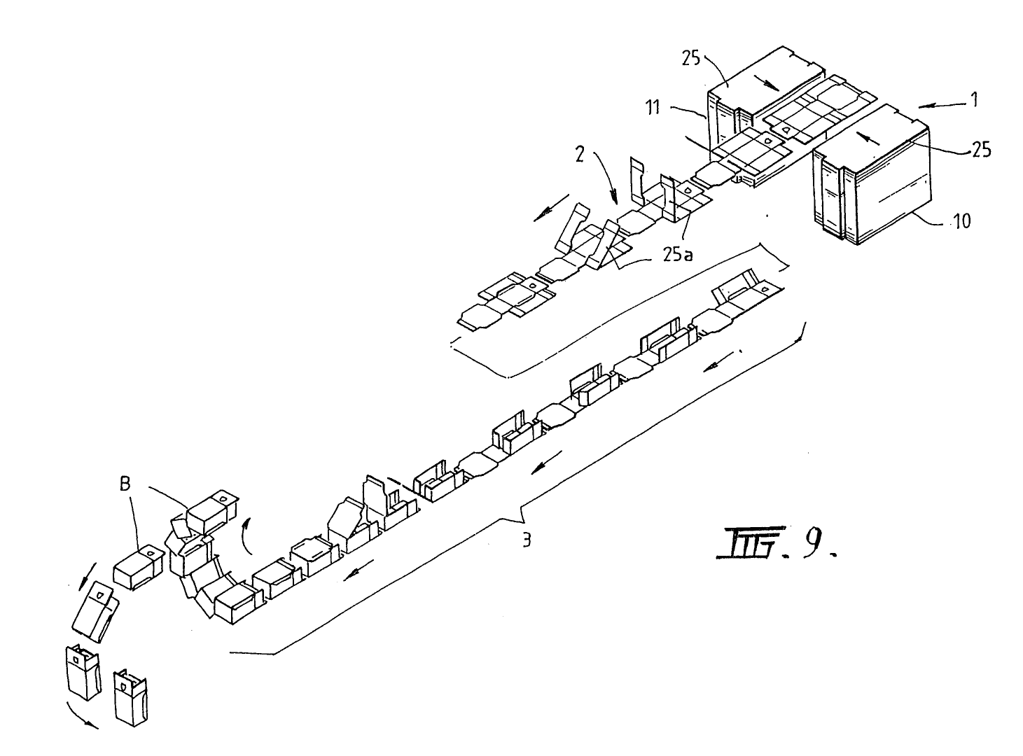

The blank side flap folding and forming section 2 receives individual blanks B supported by the side rails 5, 6, and the side flaps are folded in the manner illustrated FIG. 9 by means of a synchronised travelling carriage 20 to form glued double thickness side walls and end flaps. In FIGS. 1 and 2 of the drawings, the side flaps 12a of a blank 12 are shown in the process of being folded. The carriage 20 (FIG. 6) travels at the same speed as the blank B and includes a top hold-down actuator (not shown) of known design, to ensure the correct crease on the side flap is bent. Centre wheels or a belt 22 are incorporated to ensure the centre of the blank B stays flat and horizontal. A rotating folding arm (not shown) then moves from below the blank surface to fold the side flap up to 90 degrees vertical before dropping back down between the guides.

Static guides, or hoops (not shown) subsequently plough the side flaps from 90 degrees through to 180 degrees as the blank travels forward. The side flaps then enter the compression stage (rollers or belt) for a minimum of 0.7 seconds duration, which is sufficient time for the glue to set.

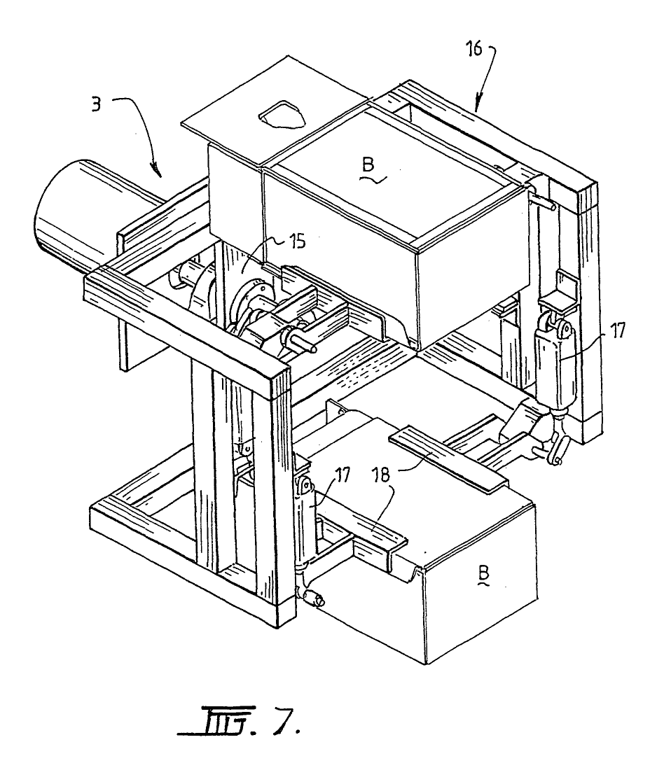

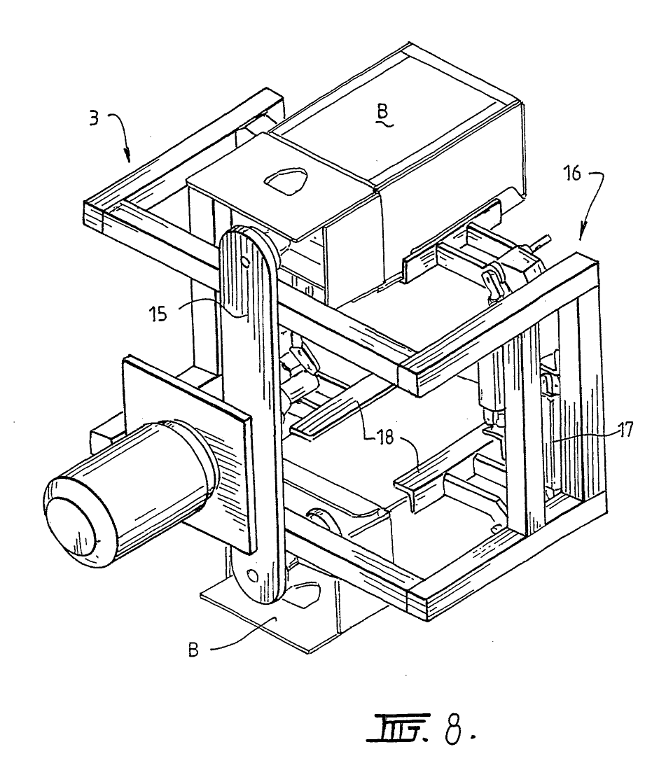

Referring now to FIGS. 1, 2, 7 and 9 of the drawings, the rotating mandrel section 3 includes a motor driven turret 15 which carries a supporting frame 16 and a pair of rectangular mandrels (not visible), rotatably carried at the ends of the turret 15, as illustrated in FIG. 1 of the drawings. The frame 16 carries flap clamping cylinders 17 to which angle section flap clamps 18 are articulated in the manner illustrated in FIG. 4 of the drawings, which shows the mandrels carrying two cases 20 which have been formed by folding the blank 12 around the mandrels in a known manner and in the sequence illustrated in FIG. 9 of the drawings. The folding operations are performed by folding arms associated with the mandrel frame 16, but not illustrated in the drawings. Folding arms similar to those illustrated in Australian Patent 640503 and U.S. Pat. No. 5,147,271, the contents of which are incorporated herein by cross reference, may be used.

As will be apparent from above, the following actions are completed in the mandrel section 3 of the machine:

The blank is positively located in the forming position

It is then clamped to the underside of the mandrel and simultaneously the sides are folded up

Vertical guided cylinders with curved forming horns are used to fold the minor flaps in

The full major end flap is then folded up and over the mandrel and pressure is applied to the closure tabs for about 0.7 seconds, until the glue is set.

During transfer of the blanks B, the following operations are performed:

Glue is applied to the sides

The sides are folded and compressed

The belt drive run time is monitored by trigger photo electric sensors to ensure that only single blanks B are fed into the system, and the belt is turned on and off by a clutch whilst the motor runs continuously. The blanks B may be conveyed through the machine by a driven dog (not shown) which pushes the trailing edge of each blank to continuously present blanks to the side flap folding and forming section 2 and to the rotating mandrel section 3.

Alternate mandrel rotations are in the opposite directions (simplifying loom design).

On startup magazine 11 is to move to the full down position where it can be refilled.

Magazine 11 block pusher cylinder 14 moves into the retracted position (towards the centre of the machine) acting as a back stop for the number one block push cycle.

Magazine 10 block pusher 13 is to be extended allowing clearance for the blanks B to raise up under it. On confirmation that the block pusher is clear the magazine will raise to a position controlled by a photo electric cell which ensures blanks are appropriately presented to the block pusher. When the infeed conveyor hopper level drops to a predetermined quantity of blanks the block pusher cylinder will retract and draw 100 mm of blanks into the hopper feed area. Confirmation that the blanks are in the feed conveyor hopper is by a reed switch mounted to the cylinder. The cylinder will subsequently extend, the magazine will raise and the process repeats as blanks are discharged through the machine and the hopper again reaches the low level.

When the magazine 10 becomes empty, magazine 11 block pusher cylinder will extend, and number one magazine block push cylinder will retract, becoming the back stop for the hopper filling process to continue from the opposite side of the machine. Magazine one tynes will automatically lower for replenishing and magazine two cycles as above to continue supplying the machine with blanks as required.

This process is controlled with each magazine being fitted with a top and bottom PE cells in addition to magazine travel over run limit switches both top and bottom. The incremental rise of the magazine will be determined by a third PE cell position, which controls the number of blanks pushed into the infeed conveyor assembly PE cell positioned in the hopper of the infeed conveyor will determine at which point the system will call for additional blanks to be delivered into the infeed area.

Each magazine is fitted with two motors rated as either 0.375 Kw or 0.55 Kw. One motor will control the raisin, and lowering the magazine forks and the second will control the size change of the magazine length. A pneumatic cylinder mounted on the top of the magazine will control magazine size in width.

For large size blanks, the front and rear infeed conveyor size chance cylinders will extend pushing the front face fully forward and the rear face fully back. Conversely, for the small blanks these cylinders retract.

There are four cylinders in all controlling the size change function, all fitted with extend and retract sensors to confirm positions of the infeed conveyor configuration. Conveyor width is also controlled using two pneumatic cylinders which when commanded will extend or retract depending on the requested configuration. Again these are fitted with extend and retract sensors.

In addition to the above the infeed conveyor is fitted with two tamper cylinders which are used to tamper the stack in the infeed conveyor area ensuring that the stack is perpendicular, ready for feeding onto the flight rails. No reed switch sensors are required for the tamper system.

The infeed conveyor belt is fitted with a 0.375 Kw or 0.55 Kw motor. This motor also derives a section nip rollers which provide a positive drive to the blanks as they transfer from the infeed conveyor to the flight rail section. It is anticipated that this motor will run continuously and drive the conveyor through a pneumatic clutch. By activating and de-activating the clutch the conveyor can be started and stopped whilst still running the nip rollers for an extended time in order to generate a gap between blanks.

The nip roller section 12 is fitted with two pneumatic cylinders on each side. One cylinder controls the nip pressure such that when the flight chain is to take control of the blank, the nip roller cylinder will release pressure on the blank. The second cylinder is positioned to retract the nip roller assembly out of the way in case of a jam up in the infeed area. In the event of a controlled stop or jam detection this cylinder would retract under reduced pressure. Extend and retract switches are to be fitted to all cylinders to indicate nip roller position.

Two lead edge detector sensors should be positioned at a blank length (1 for 15 ltr and 1 for 5 ltr) from the nip roller area to activate the glue system and nip roller release during normal function.

The folding sequence illustrated in FIG. 9 of the drawings should be read in conjunction with the description of International Patent Application No. PCT/AU00/01215 which defines in greater detail the blank and its various flap and folding alternatives. The partly folded blank produced in section 2 of the machine is presented to the lower most mandrel and is then clamped to the underside of the mandrel by a clamping plate or the like (not shown). At this time the sides of the blank are folded upwardly by folding arms or the like and means such as vertical guided cylinders with curved forming horns are used to fold the minor flaps against the mandrel. At this time, the major end flap is then folded upwardly and over the mandrel and pressure is applied to the closure tabs by means of the clamps 18. The mandrel is then rotated while the closure tab clamps 18 are held in place which provides sufficient time for the glue which has previously been applied to the blank in a known manner to be sufficiently set for the completed open-topped carton to be removed from the mandrel by suitable means (not shown) for presentation to a bag insert conveyor.

The operation illustrated in FIG. 5 of the drawings may be summarised as follows:

Die-cut blanks are loaded into an upright magazine. At Stage 1, a blank is transferred by vacuum onto a horizontal guide means (rails 5, 6).

Blanks are transferred horizontally past glue nozzles to Stage 2, where the twin side wall is folded and glued under compression.

Partially formed blanks are then transferred to Stage 3 where the case is erected around a mandrel:

1. Blank is transferred, positioned under the mandrel and clamped;

2. Side walls (now double thickness) are folded up to vertical;

3. Minor end flaps (double thickness) folded in;

4. Large top flap is folded up and over;

5. Side tabs are folded over and glued to the side wall to seal the box, leaving one end open;

6. “hold” while mandrels rotated;

7. Eject from the mandrel to the side.

The case is then discharged onto customer conveyor standing up. The carton is ready for top loading prior to closing of two minor flaps, full height end flap, and fold over closure-tab.

To summarise

Recirculating dogs push the blank through the glue and first fold section. Speed must be synchronised so that the dog is travelling at the same speed as the nip rollers as the board exits the feed section of the machine. Once clear, the dogs may speed up if this is required to improve machine throughput.

Two driven synchronised guides 20, one on either side of the machine, are then used to locate the correct fold line and facilitate breaking the middle crease on the major flaps. Small cylinders drive the flaps up and force them through a plough.

Once folded, the major flaps are compressed. Rollers are driven synchronised to the dog, and the blank is positively transferred through compression and under the mandrel prior to the dog disengaging. As the board exits the compression drives the minor flaps are broken by two small cylinders from underneath.

A clamp plate then lifts the blank onto the bottom face of the mandrel. Two folding arms attached to the clamp plate fold the major flaps against the side walls of the mandrel and the minor flaps in against the end. The bottom and front faces of the box are then folded up and over the mandrel before the flue tabs are pressed down and held in compression.

The mandrel is then rotated about the horizontal axis parallel to the center line of the machine, during which time the glue tabs are held in compression.

Following compression, the formed box is then pushed/driven off the mandrel onto the exit conveyor.

Section 2 includes known glue applying heads (not shown) which apply glue to the flaps prior to folding.

Glue is applied to the major end flap to avoid complications with folding and retaining the minor flaps. Glue is applied to side flaps (from the under side) rather than the final closure tabs to minimise the open time. Control of the glue timing is by encoder and trigger photo electric sensors. Three nozzles (not shown) are required each side, each mounted from above. The glue application timing and positioning will be controlled by an encoder and trigger photo electric sensor arrangement.

By forming the case around a mandrel, strong glue joints can be ensured, together with a uniform size and shape.

1. A case or carton forming machine having means for supporting stacked supplies of blanks for forming the box or carton at spaced positions relative to the feeding means, means for moving the blanks from each of said supplies to the blank feeding means, said moving means operating to take blanks from one supply until it is exhausted, and means for causing the moving means to take blanks from the other supply to enable the exhausted supply to be replenished while the moving means continues to supply blanks to the feeding means.

2. The machine of claim 1, wherein the stacked supply of blanks are located at either side of the blank feeding machines and a mechanism is provided to transfer blocks of blanks to the blank feeding means to maintain a supply of blanks at the feeding means.

3. The machine of claim 2, wherein the mechanism includes a block pusher associated with each stacked supply which includes stack elevating means for maintaining each stack at the required level for transfer of blocks of blanks to the blank feeding means.

4. A case or carton forming machine having a blank feeding means which receives blanks from a stacked supply of blanks, means for gluing, folding and compressing side wall flaps of the blank to for reinforced side walls and end flaps, mandrel means about which glued blanks are folded and held to form an open case or carton, said mandrel means including first and second mandrels mounted in spaced relation on a rotating turret which also carries associated blank holding means associated with each mandrel and including flap clamping means for holding closure flaps of the blank in place while the glue sets, said machine being operable to rotate the mandrels when a case or carton has been formed on a mandrel while the case or carton is held by said blank holding means to ensure that the glue sets and to present an empty mandrel about which the next blank is to be folded, thereby ensuring that throughput is not compromised while the glue sets.

5. A case or carton forming machine including blank feeding means operative to move the blanks in a predetermined direction, spaced side flap folding means for folding side wall flaps at opposite sides of the blanks in the direction of movement of the blanks about a predetermined fold line extending transverse to said direction, said folding means including means for confining the folding of the side wall flaps to said predetermined fold line.

6. The machine of claim 6, wherein the confining means includes a travelling carriage means which moves with the blank and has means for holding the blank as it is folded about the predetermined folding line.

7. The machine of claim 7, further including means, such as centre wheels or a driven hold down belt, to hold the centre of the blank down as the side wall flaps are folded.
